(19) United States
(12) Patent Application Publication
(10) Pub. No.: US 2026/0290639 A1
(43) Pub. Date: Sep. 24, 2026

(54) ENHANCED OXIDATIVE DECLADDING TECHNOLOGY FOR RECOVERY OF USED NUCLEAR FUEL

(71) Applicant: CURIO SOLUTIONS, LLC, Inwood, NY (US)

(72) Inventors: Vikram Singh, Inwood, NY (US); Alexander McGuire Wheeler, Inwood, NY (US); Cemal Cakez, Inwood, NY (US); Jacques Mosseri, Inwood, NY (US); Emre Kavlak, Inwood, NY (US); Basya Korin, Inwood, NY (US)

(73) Assignee: CURIO SOLUTIONS, LLC, Inwood, NY (US)

(21) Appl. No.: 19/568,474

(22) Filed: Mar. 16, 2026

Related U.S. Application Data
(60) Provisional application No. 63/775,474, filed on Mar. 21, 2025.

(51) Int. Cl. G21F 9/00; G21F 9/30

(52) U.S. Cl. CPC G21F 9/007; G21F 9/30

(57) ABSTRACT

A system for oxidative decladding for recovery of used nuclear fuel (UNF) has a vessel. At least one gas inlet port is formed in the vessel for injecting reagent gases into the vessel. At least one gas outlet port is formed in the vessel for discharging off gases and waste gases out of the vessel. At least one fuel basket is removably positioned within the vessel, the at least one fuel basket supporting a plurality of UNF rods. A plurality of heating elements flank the at least one fuel basket. When an oxygen enriched gas is injected into the at least one gas inlet port, the plurality of heating elements convert UO₂ matrix in the UNF rods to U₃O₈ and comminute fuel meat from claddings of the plurality of UNF rods.

### RELATED APPLICATIONS

This patent application is related to U.S. Provisional Application No. 63/775,474 filed Mar. 21, 2025, entitled “ENHANCED OXIDATIVE DECLADDING TECHNOLOGY FOR RECOVERY OF USED NUCLEAR FUEL”, in the names of the same inventors which is incorporated herein by reference in its entirety. The present patent application claims the benefit under 35 U.S.C § 119 (e) of the aforementioned provisional application.

### BACKGROUND

The U.S. commercial nuclear power sector has generated approximately 96,000 metric tons of used nuclear fuel (UNF), which may present both an environmental challenge and may provide a significant untapped energy source. Recycling the UNF may be a means to recover economically valuable materials while minimizing the quantity of high-level waste destined for geologic disposal. Because of pellet-cladding interaction, all fuel reprocessing schemes for light-water reactors (LWR) should use some efficient means of separating the UNF pellets from the cladding while minimizing residual UNF in the cladding hulls. This may generally be referred to as “decladding.”

LWR form the predominant type of reactor in operation around the world today. These reactors can be further divided into pressurized water reactors (PWR) and boiling water reactors (BWR) depending on whether boiling of the coolant is allowed within the reactor's pressure vessel. LWR fuel generally takes the form of uranium oxide pellets encased in a cladding to form rods of various lengths (e.g., 14 ft for typical PWR and 10 ft for typical BWR). These fuel elements may be comprised into fuel assemblies (typically 17×17 for PWR and 10×10 for BWR). These assemblies in turn are arranged in a lattice to form fueled region of the reactor core.

LWR fuel spends between 4.5 to 5 years in a reactor during which it participates in the fission chain reaction as the enriched uranium depletes and fission products are formed. Owing to the physical properties of the fuel and the generation of fission product gases, the uranium oxide pellets deform and then interact with the inner lining of the cladding both mechanically and chemically. This pellet-cladding interaction is such that the fuel meat (i.e., deformed uranium oxide pellet which constitutes the chemically relevant and recoverable radioactive used fuel) requires separation from the cladding prior to subjecting the fuel to further chemical separation processes, i.e., “decladding.”

Voloxidation is a dry head-end nuclear fuel reprocessing technique, usually involving roasting sheared spent oxide fuel in an air or oxygen atmosphere at 450° C. to 650° C. It may oxidize UO₂ to U₃O₈, causing a crystal lattice expansion that pulverizes the fuel, effectively releasing volatile fission products, primarily tritium ³H, volatiles, and noble gases into an off-gas stream before subsequent processing.

Voloxidation of spent nuclear fuel may present some challenges, including the need for precise temperature control (often ~500° C.) to manage oxidation rates, handling of radioactive volatile fission products, and difficulties in removing fission product residue from the oxidized fuel, which may require complex downstream processing.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a system for oxidative decladding for recovery of used nuclear fuel (UNF) is provided. The system has a vessel. At least one gas inlet port is formed in the vessel for injecting reagent gases into the vessel. At least one gas outlet port is formed in the vessel for discharging off gases and waste gases out of the vessel. At least one fuel basket is removably positioned within the vessel, the at least one fuel basket supporting a plurality of UNF rods. A plurality of heating elements flank the at least one fuel basket. When an oxygen containing gas stream is injected into the at least one gas inlet port, the plurality of heating elements convert UO₂ matrix in the UNF rods to U₃O₈ and comminute fuel meat from claddings of the plurality of UNF rods.

According to an embodiment of the disclosure, a system for oxidative decladding for recovery of used nuclear fuel (UNF) is provided. The system has a vessel composed of a material that is compatible with oxidative and reductive atmospheres up to 800° C. and overpressure conditions of up to 2 atm. The vessel has a main vessel unit having an open top and a lid coupled to the main vessel unit and enclosing the open top to form a gas tight seal. A coating is formed in an interior of the main vessel, the coating being one of: high-purity alumina (Al₂O₃) or fused quartz/silica (SiO₂). A first inlet port is formed in the main vessel for injecting the oxygen containing gas into the vessel. A second inlet port is formed in the main vessel for injecting hydrogen containing gas into the vessel. At least one gas outlet port is formed in the main vessel discharging off gases and waste gases out of the vessel. At least one fuel basket is removably positioned within the vessel, the at least one fuel basket comprises a container divided into a plurality of compartments, each compartment configured to hold a portion of a plurality of UNF rods in an upright manner, the container having a bottom surface and side walls extending up from the bottom surface, wherein the bottom surface and side walls have a meshed configuration allowing for decladding and separation of UNF meat in pulverized form to fall through the meshed configuration. A basket support is formed within the vessel, the basket support securing the at least one basket within the vessel in an upright manner and for distributing a weight of the at least one basket to a load bearing structure. A plurality of heating elements flank the at least one fuel basket. A funnel is formed on a bottom area of the main vessel. When the oxygen enriched gas is injected into the first inlet port, the plurality of heating elements convert UO₂ matrix in the UNF rods to U₃O₈ and comminute the fuel meat from claddings of the plurality of UNF rods, wherein the hydrogen gas injected from the second inlet port is used for hydrogen reduction of the fuel meat.

According to another embodiment of the disclosure, a method for recovering used nuclear fuel (UNF) from UNF rods is provided. The method comprises: debunding UNF rods from a light water reactor (LWR) fuel assembly; perforating each UNF rod down a length of each UNF rod; placing each UNF rod in a fuel basket, the fuel basket comprising a container divided into a plurality of compartments, each compartment configured to hold a plurality of the UNF rods in an upright manner, the container having a bottom surface and side walls extending up from the bottom surface, wherein the bottom surface and side walls have a meshed configuration allowing for decladding and separation of UNF meat in pulverized form to fall through the meshed configuration; placing the fuel basket into a vessel composed of a material that is compatible with oxidative and reductive atmospheres up to 800° C. and overpressure conditions of up to 2 atm, wherein the vessel comprises: a main vessel unit having an open top; and a lid coupled to the main vessel unit and enclosing the open top to form a gas tight seal; injecting oxidizing reagents into the vessel, wherein the oxidizing reagents is an oxygen enriched gas; and heating an interior of the vessel with a plurality of heating elements flanking the fuel basket to a temperature between 300° C. and below 700° C.; wherein the plurality of heating elements convert UO₂ matrix in the UNF rods to U₃O₈ and comminuting the fuel meat from claddings of the plurality of UNF rods, wherein a hydrogen gas injected into the vessel is used for hydrogen reduction of the fuel meat.

### BRIEF DESCRIPTION OF THE DRAWINGS

FIG. 1A is a side view of an exemplary nuclear fuel rod, in accordance with an embodiment of the disclosure;

FIG. 1B is a side view of an exemplary swollen nuclear fuel rod, in accordance with an embodiment of the disclosure;

FIG. 1C is a side view of an exemplary nuclear fuel rod at an end of life, in accordance with an embodiment of the disclosure;

FIGS. 2A-2D show Scanning Electron Microscope (SEM) images of pellet-cladding interaction showing spent fuel/ZrO₂/Zr-liner interface region and “jets” of uranium penetrating the ZrO₂ layer, in accordance with an embodiment of the disclosure;

FIGS. 3A-3B show SEM images showing the morphological differences in pure U₃O₈ particles (3A) vs post-oxidation SIMFUEL particles (3B) as SIMFUEL morphology closely resembles UNF, in accordance with an embodiment of the disclosure;

FIG. 4 is a graph displaying UO₂→U₃O₈ conversion kinetics model for different conditions including O₂ conc., and agitation, in accordance with an embodiment of the disclosure;

FIG. 5 is a graph displaying UO₂→U₃O₈ conversion particle size distribution versus temperature, in accordance with an embodiment of the disclosure;

FIGS. 6A-6C show micrographs of post-oxidation SIMFUEL particulates at 450° C. (6A), 500° C. (6B), 600° C. (6C), in accordance with an embodiment of the disclosure;

FIGS. 7A-7C show high magnification SEM images showing surface morphology of SIMFUEL (7A), EDS mapping of region shown in FIGS. 7A (7B), and showing the granular microstructure of post-oxidation SIMFUEL (7C), in accordance with an embodiment of the disclosure;

FIGS. 8A-8D show images of deformation but not unzipping of a used nuclear fuel (UNF) rod (8A), unzipping in a subsequent run (8B), ANSYS finite-element analysis showing a 4× increase in equivalent stress from changing perforation geometry (8C-8D), in accordance with an embodiment of the disclosure;

FIG. 9 shows an exemplary flowsheet showing oxidative decladding process for LWR UNF rods, in accordance with an embodiment of the disclosure;

FIG. 10 shows a cross-sectional view of an exemplary reactor vessel used in the oxidative decladding process shown in FIG. 9, in accordance with an embodiment of the disclosure;

FIG. 11 shows a cross-sectional view of an exemplary basket used in the reactor vessel shown in FIG. 10, in accordance with an embodiment of the disclosure;

FIG. 12 shows a cross-sectional view of an exemplary heating element used in the reactor vessel shown in FIG. 10, in accordance with an embodiment of the disclosure;

FIG. 13 shows a cross-sectional view of an exemplary funnel used in the reactor vessel shown in FIG. 10, in accordance with an embodiment of the disclosure;

FIG. 14 shows a cross-sectional view of an exemplary sieve used in the reactor vessel shown in FIG. 10, in accordance with an embodiment of the disclosure;

FIG. 15 shows a side view of an exemplary scaffold used with the reactor vessel shown in FIG. 10, in accordance with an embodiment of the disclosure;

FIG. 16 shows a top view of an exemplary scaffold used with the reactor vessel shown in FIG. 10, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

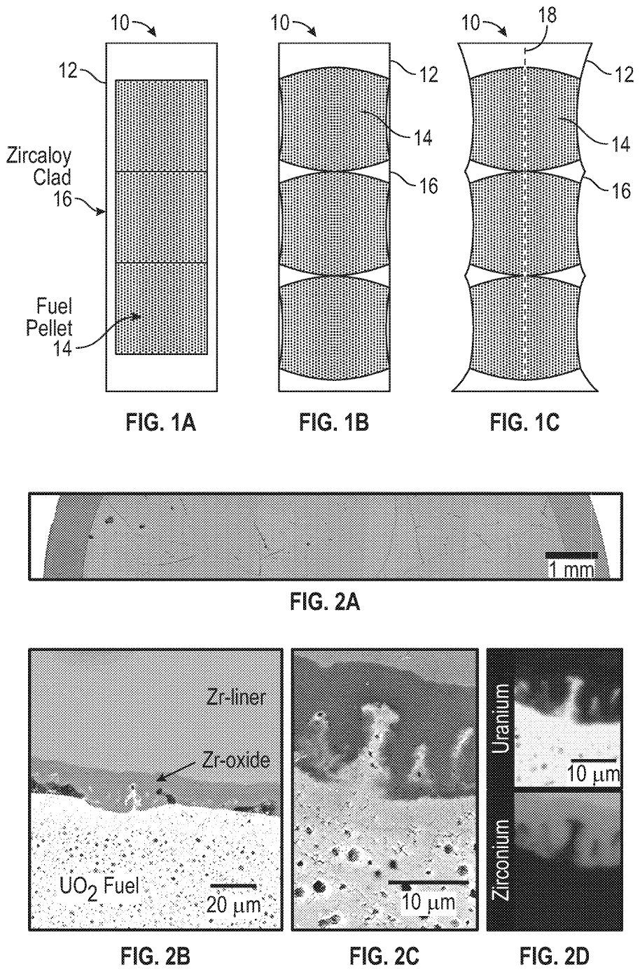

Referring to FIG. 1A, a nuclear fuel rod 10 (hereinafter fuel rod 10) may be shown. In general, the fuel rod 10 for a LWR, is a sealed, long, slender, cylindrical tube 12 designed to contain nuclear fuel and fission products, i.e., fuel pellets 14. The cylindrical tube 12 may be formed of a Zirconium alloy cladding 16 with the top and bottom ends of the cylindrical tube 12 plugged.

Referring to FIG. 1B, over time, during usage, the fuel cell 10 may begin to swell. Fuel swelling may be defined as the increase in the volume of the fuel pellets 14 caused by the accumulation of solid and gaseous fission products within the fuel matrix during irradiation. This may result in Pellet-Cladding Mechanical Interaction (PCMI) which may refer to the direct physical contact and resulting stress between the fuel pellets 14 and the cylindrical tube 12. As the fuel pellet 14 swells and expands during operation, particularly during power increases (ramps), the fuel pellet 14 may exert force on the cladding 16, causing cylindrical tube 12 with the Zirconium alloy cladding 16 to deform as may be shown in FIG. 1C.

The present disclosure provides a system and method for the recovery of used nuclear fuel in pulverized form from used nuclear fuel (UNF) rods 10. The present disclosure provides an oxidative decladding system and method that can be used to recover the fuel meat from the cladding of the UNF rods 10. The system and method accomplishes this by employing an advanced voloxidation process that builds upon the historical Atomics International Reduction Oxidation (AIROX) process with the objective of achieving large-scale, single-step, oxidative decladding of full-length UNF rods 10. Compared to traditional processes for decladding which employ a nitric acid bath to leach the fuel “meat” from the cladding and as such may suffer from having to deal with a large atmosphere containing radioactive gases, the process disclosed here employs a dry, oxygen-rich atmosphere in a contained environment to enable more efficient sequestration of the radioactive off-gases. With full-length UNF rods 10 capable of being subjected to the process, the disclosed process also foregoes the need for shearing the fuel rods and the associated potential issues of contamination of the process area. Although the disclosed process can also be conducted with sheared rodlets, the desired embodiment enables processing with full-length rodlets.

The present disclosure provides an advanced oxidative decladding process. The process begins by debundling the individual UNF rods 10 from an LWR fuel assembly. The UNF rods 10 may be perforated and held in a high-temperature, oxygen-rich atmosphere to convert the UO₂ matrix to U₃O₈ and comminute the fuel meat in the process. A ~36% increase in the crystalline volume and a 2-5× change in bulk volume pulverizes the fuel and efficiently separates it from cladding 16 (<0.5 wt. % UNF remaining). The general reaction can be described as follows:

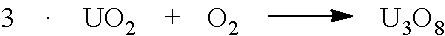

The irradiated fuel's burnup level determines the exact physico-chemical characteristics of the fuel meat including the degree of pellet-cladding interaction. As such, a hydrogen reduction step may be necessary either before, or after the oxidation step, to efficiently separate the fuel meat from the cladding. In some cases, it may be necessary both before and after. All these variations of the process are incorporated herein.

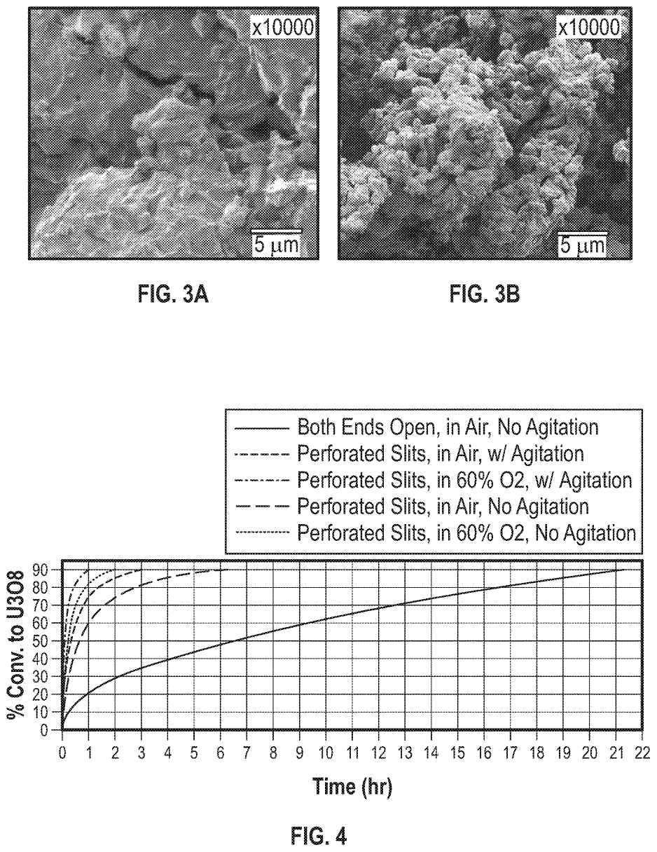

The present process provides several key advancements to enable scalable deployment of this oxidative decladding process. Conversion kinetics were studied by devising a simulant of used nuclear fuel—SIMFUEL—where depleted uranium oxide was mixed with oxides of non-radioactive fission products representing a PWR fuel rod that has experienced 50 GWd/t of burnup and cooled for 5 years. The mixed oxides were pressed and sintered to form pellets that were loaded into tight-fitting zirconium cladding. This SIMFUEL was observed to mimic UNF both in chemistry and microstructure as may be shown in FIGS. 3A-3B.

Laboratory-scale tests were performed in collaboration with U.S. national laboratories to investigate process parameters for which the oxidative decladding process disclosed here yielded optimal decladding and pulverization of the SIMFUEL creating a particulate product possessing uniform characteristics. The kinetics of the process were observed to be sensitive to the perforation geometry, composition of oxidating atmosphere, the absolute temperature of the reaction zone, and the degree of agitation of the fuel. A graph showing the salient results from modeling which agreed closely with laboratory experiments may be shown in FIG. 4. FIGS. 3A-3B are Scanning Electron Microscope (SEM) images. FIG. 3A shows the morphological differences in pure U₃O₈ particles vs post-oxidation SIMFUEL particles shown in FIG. 3B. SIMFUEL morphology closely resembles UNF.

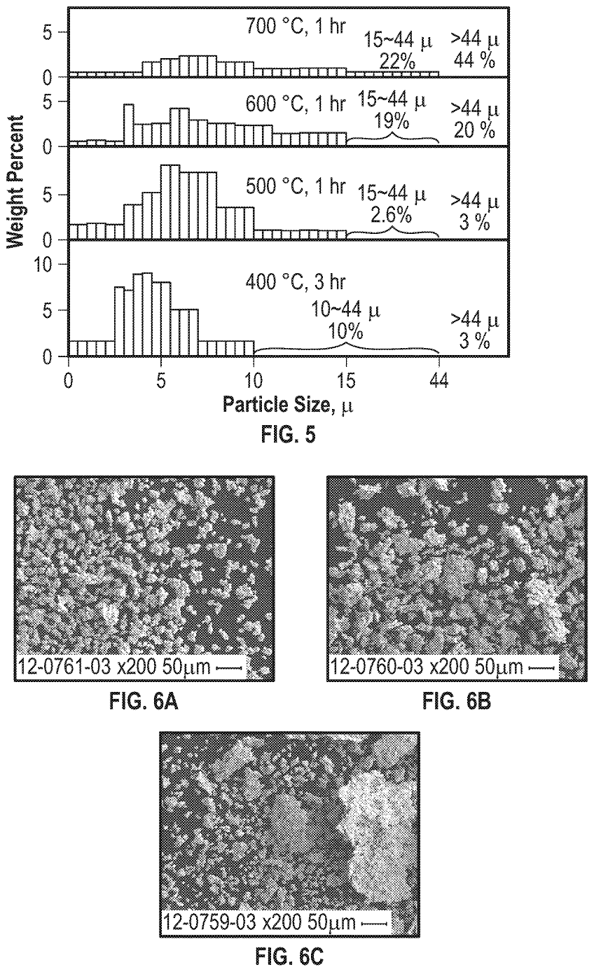

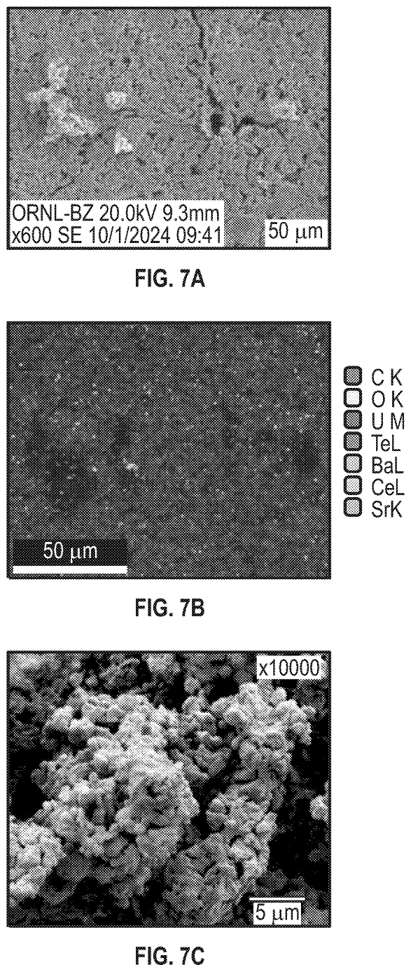

In general, it was found that the reaction is most favorable above 300° C. and below 700° C., with the average particle size increasing with increasing temperatures as may be shown in FIGS. 6A (450° C.), 6B (525° C.), and 6C (600° C.). FIG. 4 is a graph that shows UO₂→U₃O₈ conversion kinetics model for different conditions including O₂ conc., and agitation. FIG. 5 is a graph showing UO₂→U₃O₈ conversion particle size distribution versus temperature.

The presented oxidative decladding system and method may be conducted with oxidizing reagents including, but not limited to: air, oxygen in argon (varying proportions), NO₂, and ozone. Various mechanical agitation methods may be employed including, but not limited to: pneumatic agitation, vibrational agitation, etc. While reaction speed can be increased via agitation, as may be seen in FIG. 4, it may complicate equipment design.

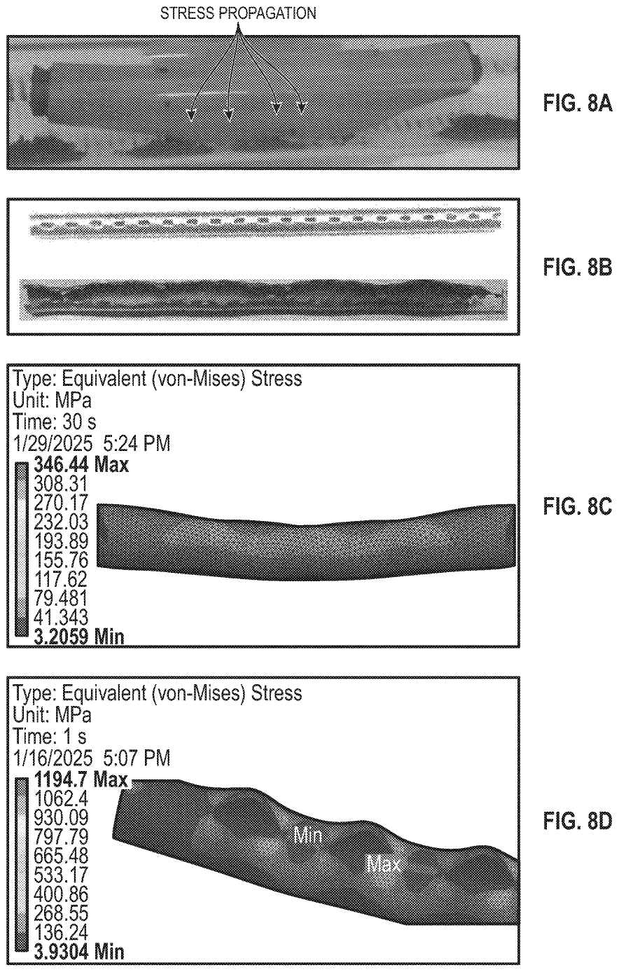

Laboratory-scale tests were conducted to generate a matrix of data to explore the most advantageous combination of parameters enabling large-scale oxidative decladding. Finite element analysis models were constructed and validated through comparison with laboratory results. Two such instances are shown in FIGS. 8A-8D elucidating the effect of perforation geometry and the resulting cladding failure seen as rodlet splitting (or unzipping).

Referring to FIGS. 8A-8D, results of the laboratory-scale tests may be shown. In FIG. 8A, it may be shown that the cladding did not fail and the SIMFUEL pellets underwent partial oxidation. In FIG. 8B, it may be shown that the cladding split lengthwise, resulting in >99.75% separation of SIMFUEL from cladding. Perforating the UNF rods prior to voloxidation has been historically overlooked as a means of scaling up this process, and the presented evidence indicates the importance of perforation (or another means of cladding weaking prior to oxidation), and the dependence of the process on geometry of such perforations. In FIGS. 8C-8D, it may be shown that finite-element analysis may provide a 4× increase in equivalent stress from changing perforation geometry. Thus, the above results support the scalability of the process to accept and declad full-length LWR UNF rods.

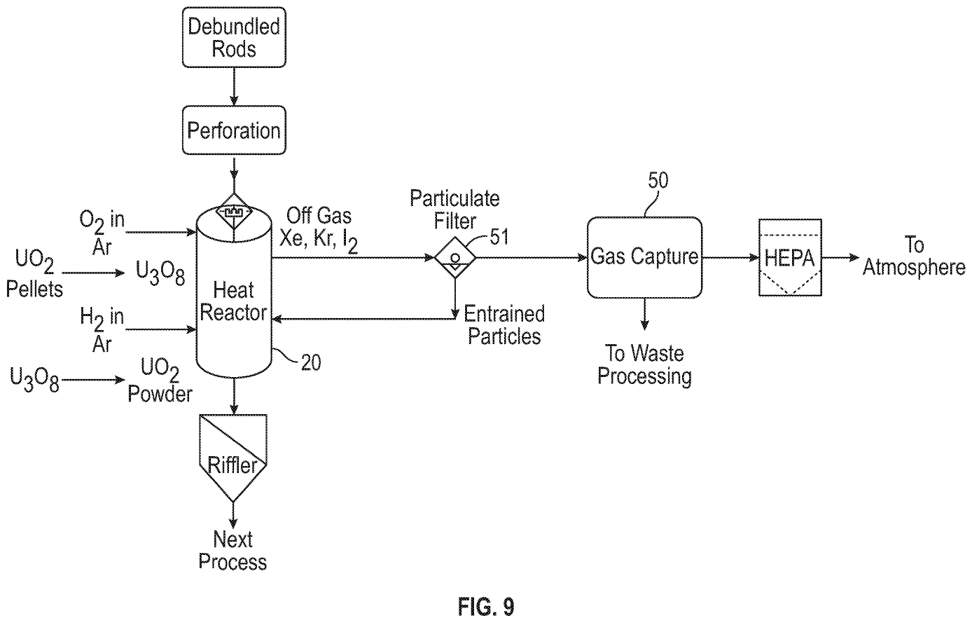

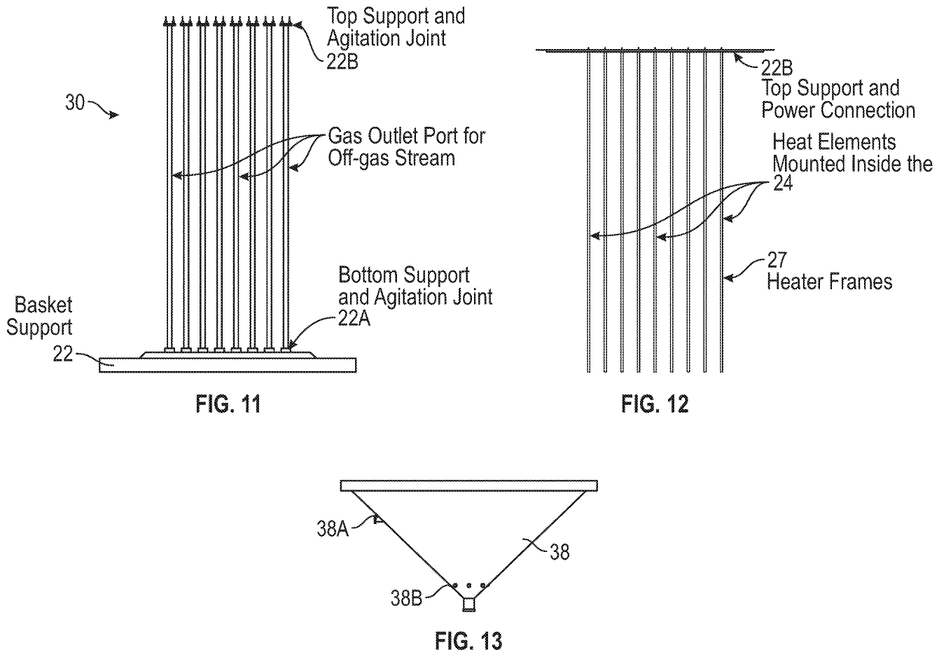

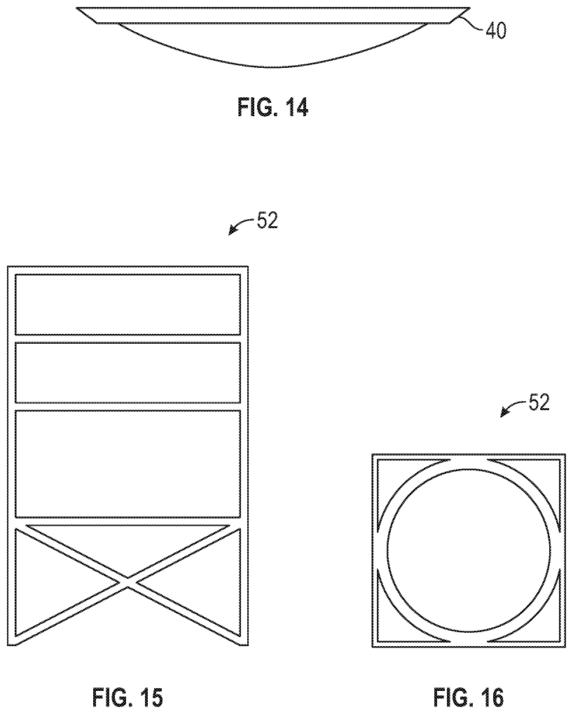

Referring now to FIGS. 1C and 9-16, the system and method may be disclosed. The process accepts full-length UNF rods 10 by first debundling the individual UNF rods 10 from an LWR fuel assembly. The individual UNF rods 10 may then have perforations 18 formed lengthwise therein. The UNF rods 10 may be loaded into UNF-load basket 30 that may be held in the reactor vessel 20 with a support structure 22. The support structure 22 may be secured within an interior 20A of the reactor vessel 20. The support structure 22 may have a top support structure 22B and a bottom support structure 22A. The bottom support structure 22A may be coupled to a bottom area of the reactor vessel 20 and may be used to carry the weight of the UNF-loaded basket 30, whereas the top support structure 22B may be coupled to an upper area of the reactor vessel 20 and may be used to hold the UNF-load basket 30 in place and prevent sideways movement. The UNF-load baskets 30 may be flanked on both sides by cladded heating elements 24 for radiative heating. This arrangement may provide adequate heating to the UNF rods 10 along their entire length and on all sides for increased reaction efficiency. The heating elements 24 may be suspended from the top support structure 22B. This may provide the ability to load and unload the UNF-load baskets 30 during subsequent batches and may enable replacement of the heating elements 24, as needed, for maintenance purposes.

The reactor vessel 20 may be cylindrical and may be composed of a material that is compatible with the oxidative and reductive atmospheres up to 800° C. and overpressure conditions of up to 2 atm. Some materials of construction may include, but is not limited to, stainless steels of 300 and 400 series, Inconel 600 or 625, Hastelloy C-276, and similar types of materials. Depending on the specific final configuration of the desired reactions, inner walls 20B of the reactor vessel 20 may be spray coated with high-purity alumina (Al₂O₃) or fused quartz/silica (SiO₂), both of which may provide excellent barrier performance with the aforementioned reactants at temperatures that far exceed 800° C.

Reagent gases may be introduced into the reactor vessel 20. The reagent gases may be introduced by gas inlets 26. As stated above, the reagent gases may include, but not limited to: air, O₂ in argon (varying proportions), NO₂, ozone O₃, and like gases. The gas inlets 26 may be formed near the bottom of the reactor vessel 20. The disclosed process may produce a mixture of off gases which contain valuable components (Xe, Kr, ³H₂O) as well as waste gases (I₂, MoO₃, CsO, Tc₂O₇, etc.,). The off-gas mixture may be routed to a capture system 50 through outlets 28 formed in the reactor vessel 20. The outlets 28 may be formed near the top of the reactor vessel 20. In accordance with one embodiment, a particulate filter 51 may be coupled between the outlets 28 and the capture system 50.

A hydrogen reduction step may be necessary either before, or after the oxidation step, to efficiently separate the fuel meat from the cladding. In some cases, it may be necessary both before and after. Thus, a gas inlet 27 may be formed near the bottom of the reactor vessel 20. The gas inlet 27 may be used for injecting hydrogen gas for a hydrogen reduction of the fuel meat.

The UNF-load basket 30 may come in different configurations and materials. In accordance with one embodiment, the UNF-load basket 30 may be rectangular in shape and may be formed entirely of compatible structural alloys. The compatible structural alloys may be the same and/or similar the materials used to form the reactor vessel 20.

The reactor vessel 20 may be configured to hold multiple UNF-load baskets 30. Each UNF-load basket 30 may contain hundreds of UNF rods 10 such that each batch processes several hundred kilograms to a few metric tons of UNF. The space within the UNF-load basket 30 may be sub-divided into two or more compartments 30C such that the UNF rods 10 may be kept vertically aligned and to prevent disarray. This arrangement may help to exploit the rod unzipping behavior and reaction kinetics as disclosed above to provide scalable decladding and separation of the UNF meat in pulverized form.

The bottom 30A and side walls 30B of the UNF-load basket 30 may have a meshed face such that may allow the produced powders to fall through, but the unzipped UNF rods 10 may remain inside their respective compartments 30C. The UNF-load basket 30 may stand erected on the bottom support structure 22B. A carrying mechanism 32 may be coupled to a top area of the UNF-load basket 30 to move the UNF-load basket 30. In accordance with an embodiment, the carrying mechanism 32 may be eye nuts that may be attached to the top corners of the UNF-load basket 30. The eye nuts may be attached to a lifting device to carry the UNF-load basket 30 to and from the reactor vessel 20.

As previously disclosed, the support structure 22 may be secured within an interior 20A of the reactor vessel 20. The support structure 22 may be used to carry the weight of the UNF-loaded basket 30, serve as a load distribution pathway which may distribute the weight of the UNF-load basket 30 containing the UNF rods 10 to load-bearing structures of a building which may house the process, and serve as a base for an agitator.

The support structure 22 may have a top support structure 22B and a bottom support structure 22A. The bottom support structure 22A may be coupled to a bottom area of the reactor vessel 20 and may be used to carry the weight of the UNF-loaded basket 30. The bottom support structure 22A may have rectangular sections with grooves provided for ease of placement of the UNF-load basket 30. The top support structure 22B may be coupled to an upper area of the reactor vessel 20 and may be used to hold the UNF-load basket 30 in place and prevent sideways movement and serve as the base for the agitator 36.

The agitator 36 may be provided to simplify UNF powder disengagement from the cladding 16. The agitator 36 may be formed of different configurations. The agitator 36 may be of various types of agitation such as mechanical or vibrational and can be mounted to the top support structure 22A.

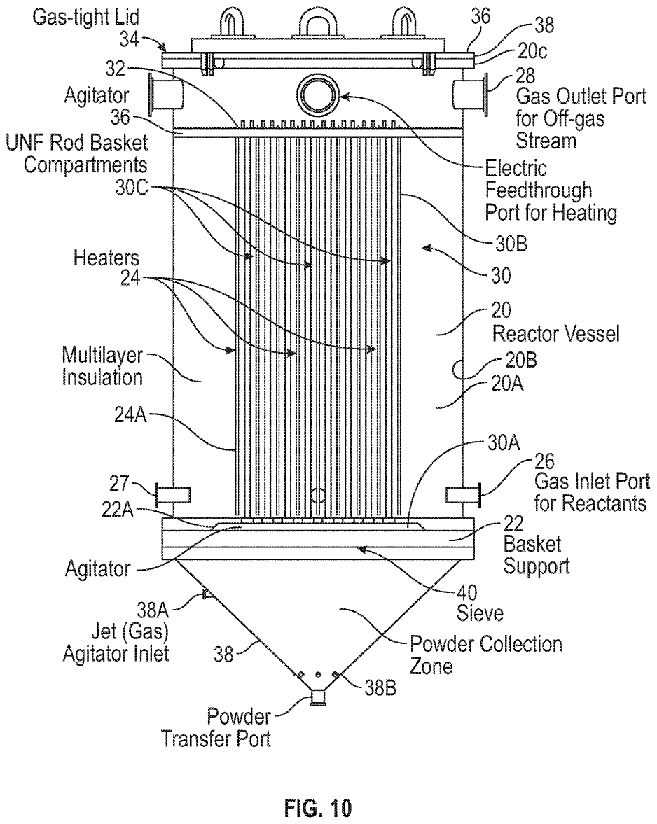

The heating elements 24 may be positioned such that they flank the UNF-load basket 30 on either side of the long edge of the UNF-load basket 30. Each heating element 24 may consist of a vertical array of heating elements. The heating elements 24 may be composed of resistance elements that may be cladded to prevent chemical reactions in the highly oxidative and reductive atmosphere within the reactor vessel 20. In accordance with one embodiment, the heating elements 24 may utilize Aluchrome Yttrium Hafnium (Aluchrome Y Hf) resistance elements made from a metal alloy with exceptional isothermal and cyclical oxidation resistance due to its high aluminum and chrome contents. A cladding/sheath 24A may be formed on the heating elements 24. The cladding/sheath 24A may be used to protect the heating elements 24 from the highly oxidative and reductive atmosphere within the reactor vessel 20. The cladding/sheath 24A may be made of various metal alloys such as Inconel 600, Inconel 800, Hastelloy B, etc. The heating elements 24 may be combined to make heater plates 25, and a heater frame 27 may hold the heater plates 25 such that the heater plates 25 may be suspended from above on the top support structure 22A. This arrangement may be shown in FIGS. 10-12.

A lid 34 may be placed on an open top area of the reactor vessel 20 to enclose the reactor vessel 20. The lid 34 may be opened and closed which may allow for the loading and unloading of the UNF-load basket 30. The lid 34 may be composed of similar structural material as the reactor vessel 20 to match the thermal expansion coefficient and form a gas-tight connection to the reactor vessel 20. In order to mitigate misalignment risk, the lid 34 may be formed with a flange 36 formed around an outer perimeter of the lid 34. In order to mitigate misalignment risk, positioning operations of the lid 34 may be facilitated by guided placeholders.

The reactor vessel 20 may have a flange 20C formed around an exterior perimeter of a top surface of the reactor vessel 20. The reactor vessel 20 may be sealed with reciprocal knife-edged flanges 20C and 36 biting a ductile O-ring gasket 38. The gasket 38 may be made of copper or similar material which may be replaced after each batch. Alternatively, the gasket 38 can also be made of high temperature elastomers such as, but not limited to, Viton, Kalrez or similar material, with temperature-controlled flanges 20C and 36 which may be actively cooled. This setup may provide a reactor vessel 20 that may provide a gas-tight sealed containment that may prevent contamination of the environment with radioactive off gases and elutriated dust.

The reactor vessel 20 may have a funnel 38. The funnel 38 may form a portion of a bottom section of the reactor vessel 20. The funnel 38 may function and serve as an exit for the produced UNF particulate product and to allow transfer of the produced UNF particulate product to the next unit operation. In accordance with one embodiment the funnel 38 may be positioned below the bottom support structure 22A. The funnel 38 shape may be based on the flowability characteristics of the UNF powder such as repose angle, Hausner Ratio, Carr Index, etc. In general, UNF powders (UO₂ or U₃O₈) display poor flow characteristics. Therefore, in one embodiment, gas bubbling inlets 38B may be provided in a circular pattern near the bottom of the funnel 38 to help fluidize the powder and allow for its unloading from the reactor vessel 20.

Near the top 38A of the funnel 38 is a set of gas inlets 38A. The gas inlets 38A may be used to introduce high-pressure gas jets which can be used to dislodge agglomerated particulates in the bottom of the UNF-load basket 30 and a sieve 40. In accordance with one embodiment, argon, or argon+reagent may be injected into the gas inlets 38A.

The sieve 40 may be positioned inside the funnel 38. The sieve 40 may act as a filter, separating larger U₃O₈ pieces and any stray pieces of cladding from the powder. The sieve 40 may sit below the support structure 22. The sieve 40 may hold broken cladding hull pieces, if any, and large particles to exhaustively pulverize them with prolonged exposure to oxidation and reduction.

A scaffolding 52 may be used to partially anchor the reactor vessel 20 to the ground. The scaffolding 52 may serve to support the reactor vessel 20 and associated components. Due to the mass of the reactor vessel 20 and the temperatures resulting from the chemical reactions, the stress generated may cause the reactor vessel 20 to deform or degrade if left unsupported. Therefore, the scaffold 52 may be used to redistribute the weight of the load from the reactor vessel 20. In the presented embodiment, the scaffold 52 may act as the intermediate in the load path for the support structure 22 and redistributes this weight to the building super-structure. One embodiment of the scaffold 52 may be shown in FIGS. 15-16.

Various modifications of the present invention, in addition to those shown and described herein, will be apparent to those skilled in the art of the above description. Such modifications are also intended to fall within the scope of the appended claims.

The foregoing description is illustrative of particular embodiments of the invention, but is not meant to be a limitation upon the practice thereof. The following claims, including all equivalents thereof, are intended to define the scope of the invention.

1. A system for oxidative decladding for recovery of used nuclear fuel (UNF) comprising:
a vessel;
at least one gas inlet port injecting reagent gases into the vessel;
at least one gas outlet port discharging off gases and waste gases out of the vessel;
at least one fuel basket removably positioned within the vessel, the at least one fuel basket supporting a plurality of UNF rods; and
a plurality of heating elements flanking the at least one fuel basket;
wherein an oxygen enriched gas is injected into the at least one gas inlet port, the plurality of heating elements converting UO₂ matrix in the UNF rods to U₃O₈ and comminuting fuel meat from claddings of the plurality of UNF rods.

2. The system of claim 1, wherein the vessel comprises:
a main vessel unit having an open top; and
a lid coupled to the main vessel unit and enclosing the open top to form a gas tight seal.

3. The system of claim 1, wherein the vessel comprises:
a main vessel unit having an open top;
a main vessel flange formed around an outer perimeter of the open top
a lid coupled to the main vessel unit and enclosing the open top;
a lid flange formed around an outer perimeter of the lid; and
a gasket, wherein the lid flange and the main vessel flange press into the gasket to form a gas tight seal.

4. The system of claim 1, wherein the vessel is composed of a material that is compatible with oxidative and reductive atmospheres up to 800° C. and overpressure conditions of up to 2 atm.

5. The system of claim 1, wherein the vessel is composed of one of: stainless steel 300 series, stainless steel 400 series, Inconel 600, Inconel 625, Hastelloy C-276, and combinations thereof.

6. The system of claim 1, comprising a coating formed in an interior of the vessel, the coating being one of: high-purity alumina (Al₂O₃) or fused quartz/silica (SiO₂).

7. The system of claim 1, wherein the at least one gas inlet port comprises:
a first inlet port for injecting the oxygen enriched gas; and
a second inlet port for injecting hydrogen gas for a hydrogen reduction of the fuel meat.

8. The system of claim 1, comprising gas capture unit coupled to the at least one gas outlet port separating the off gases and waste gases.

9. The system of claim 8, comprising a particulate filter coupled between the at least one gas outlet port and the gas capture unit.

10. The system of claim 1, wherein each of the plurality of UNF rods are full size UNF rods.

11. The system of claim 1, wherein each of the plurality of UNF rods are full size UNF rods and perforated.

12. The system of claim 1, wherein the at least one fuel basket comprises a container divided into a plurality of compartments, each compartment configured to hold a portion of the plurality of UNF rods in an upright manner, the container having a bottom surface and side walls extending up from the bottom surface, wherein the bottom surface and side walls have a meshed configuration allowing for decladding and separation of the UNF meat in pulverized form to fall through the meshed configuration.

13. The system of claim 12, comprising connectors coupled to the container allowing for raising and lowering the container in and out of the vessel.

14. The system of claim 1, comprising a basket support formed within the vessel, the basket support securing the at least one basket within the vessel in an upright manner and for distributing a weight of the at least one basket to a load bearing structure.

15. The system of claim 1, comprising a basket support formed within the vessel, the basket support securing the at least one basket within the vessel in an upright manner and for distributing the weight of the at least one basket to a load bearing structure, the basket support comprising:
a base unit formed on a lower section of the vessel having a plurality of grooves for aligning and receiving the at least one basket; and
and a top support member formed on an upper section of the vessel.

16. The system of claim 1, wherein each of the plurality of heating elements is cladded with a metal alloy that are isothermal and cyclical oxidation resistant.

17. The system of claim 1, comprising a funnel formed on a bottom area of the main vessel serving as an exit for materials produced by the system.

18. The system of claim 17, comprising gas bubbling inlets formed around a bottom area of the funnel to fluidize the materials produced by the system.

19. The system of claim 17, comprising gas inlets formed near a top area of the funnel introducing high-pressure gas jets to dislodge agglomerated particulates.

20. The system of claim 17, comprising a sieve positioned inside the funnel.

21. A system for oxidative decladding for recovery of used nuclear fuel (UNF) comprising:
a vessel composed of a material that is compatible with oxidative and reductive atmospheres up to 800° C. and overpressure conditions of up to 2 atm, wherein the vessel comprises:
a main vessel unit having an open top; and
a lid coupled to the main vessel unit and enclosing the open top to form a gas tight seal;
a coating formed in an interior of the main vessel, the coating being one of: high-purity alumina (Al₂O₃) or fused quartz/silica (SiO₂);
a first inlet port for injecting the oxygen enriched gas into the vessel;
a second inlet port for injecting hydrogen gas into the vessel:
at least one gas outlet port discharging off gases and waste gases out of the vessel;
at least one fuel basket removably positioned within the vessel, the at least one fuel basket comprises a container divided into a plurality of compartments, each compartment configured to hold a portion of a plurality of UNF rods in an upright manner, the container having a bottom surface and side walls extending up from the bottom surface, wherein the bottom surface and side walls have a meshed configuration allowing for decladding and separation of UNF meat in pulverized form to fall through the meshed configuration;
a basket support formed within the vessel, the basket support securing the at least one basketed within the vessel in an upright manner and for distributing a weight of the at least one basket to a load bearing structure;
a plurality of heating elements flanking the at least one fuel basket; and
a funnel formed on a bottom area of the main vessel;
wherein the oxygen enriched gas is injected into the first inlet port, the plurality of heating elements converting UO₂ matrix in the UNF rods to U₃O₈ and comminuting the fuel meat from claddings of the plurality of UNF rods, wherein the hydrogen gas injected from the second inlet port is used for hydrogen reduction of the fuel meat.

22. The system of claim 21, comprising a gas capture unit coupled to the at least one gas outlet port separating the off gases and waste gases.

23. The system of claim 22, comprising a particulate filter coupled between the at least one gas outlet port and the gas capture unit.

24. A method for recovering used nuclear fuel (UNF) from UNF rods, comprising:
debunding UNF rods from a light water reactor (LWR) fuel assembly;
perforating each UNF rod down a length of each UNF rod;
placing each UNF rod in a fuel basket, the fuel basket comprising a container divided into a plurality of compartments, each compartment configured to hold a plurality of the UNF rods in an upright manner, the container having a bottom surface and side walls extending up from the bottom surface, wherein the bottom surface and side walls have a meshed configuration allowing for decladding and separation of UNF meat in pulverized form to fall through the meshed configuration;
placing the fuel basket into a vessel composed of a material that is compatible with oxidative and reductive atmospheres up to 800° C. and overpressure conditions of up to 2 atm, wherein the vessel comprises:
a main vessel unit having an open top; and
a lid coupled to the main vessel unit and enclosing the open top to form a gas tight seal;
injecting oxidizing reagents into the vessel, wherein the oxidizing reagents is an oxygen enriched gas; and
heating an interior of the vessel with a plurality of heating elements flanking the fuel basket to a temperature between 300° C. and below 700° C.;
wherein the plurality of heating elements convert UO₂ matrix in the UNF rods to U₃O₈ and comminuting the fuel meat from claddings of the plurality of UNF rods, wherein a hydrogen gas injected into the vessel is used for hydrogen reduction of the fuel meat.
